(19) United States
(12) Patent Application Publication
(10) Pub. No.: US 2021/0186004 A1
(43) Pub. Date: Jun. 24, 2021

(54) PERIPHERALLY BUOYANT COLLAPSIBLE DECOY MOUNTING DEVICE

(71) Applicant: Ross Giese, Lake Geneva, WI (US)

(72) Inventor: Ross Giese, Lake Geneva, WI (US)

(21) Appl. No.: 16/724,310

(22) Filed: Dec. 22, 2019

(51) Int. Cl. A01M 31/06

(52) U.S. Cl. CPC A01M 31/06

(57) ABSTRACT

A decoy buoy for holding a plurality of waterfowl decoys that comprises a central hub with at least three arms comprising mounting holes generally equally spaced along the arms. The mounting holes are further adapted for mounting a waterfowl decoy and/or an anchoring device to prevent the decoy buoy from floating away while in the water. The decoy buy further being constructed from two sections and joined with hinges that provide both a folding configuration and an unfolded stable semi-rigid configuration adapted for placement upon or near the surface of water.

### FIELD OF THE INVENTION

The invention relates to a new and improved mounting device for decoys used for hunting. Specifically, the invention relates to a peripherally buoyant and collapsible mounting platform for decoys.

### BACKGROUND OF THE INVENTION

Evidence has shown that man used decoys while hunting waterfall as early as 2000 years ago. Early decoys were made from the available materials of the day and could be found in two dimensional and three dimensional configurations depending on the skill of the person making the decoy. They were often woven from dried vegetation and mounted on reeds which were then stuck into the mud while the birdlike decoy stayed above the water. While being somewhat effective at deceiving ducks and geese flying high overhead, their crude appearance was less than fully convincing in closer proximity. Weaponry was limited to crude bows and arrows having limited range and questionable accuracy. In addition, the rigid mounting method prevented the decoys from naturally bobbing upon the surface of the water as real ducks or geese would do. The need to draw birds in closer and in greater numbers would drive innovation.

Improvements to decoy design execution would include the use of buoyant materials that could be carved into realistic profiles, painted to look like species that would migrate through the area, and configured for flexible anchorage while maintaining floatation on the surface of the water. Modern decoys are often injection molded from various polymers with details that can fool the hunter as well as the hunted. They are often painted or otherwise decorated to reproduce the coloration and overall appearance of natural feathers while providing durability for continued reuse.

Often these decoys are configured to duplicate the appearance of a duck or goose floating on the surface of the water, or alternately the duck or goose standing on land and posed to look like it is eating, sleeping, or alert and looking for a mate. Decoys configured for standing are often used in fields that are freshly plowed. They can be deployed in significant numbers and are typically not buoyant. Waterfowl passing over in flight may observe the decoys, believe that they are live birds feeding on the grain that has fallen on the ground as a result of harvesting, and land to feed as well. Modern decoys of this type are often constructed so that they may generate life-like motion as the result of wind blowing against them. This motion helps make the decoys appear to be more realistic. The more realistic appearance is likely to attract greater numbers of birds. In contrast, water based floating decoys are often used to attract waterfowl that is looking for a place to rest safely on the water and away from predators.

During fall migration, is very common to see significant numbers of ducks and or geese floating upon the surface of the water. The depth of the water in a lake, pond, creek, or river often protects waterfowl from many predators, such as fox, coyotes, dogs, badgers, etc. Therefore, waterfowl decoys that float upon the water are used to attract birds that need a safe place to rest. An ideal habitat for waterfowl may be a body of water having a depth suitable for flotation around its periphery and shallower portions a safe distance from shore suitable for the collection of water-borne insects or other desirable nourishment by waterfowl that could support its own weight while standing. Unfortunately, ponds and rivers seldom have these combined features.

The known prior art relies upon the use of buoyant decoys or otherwise utilizes folding “V” shaped boards such as those described and shown in U.S. Pat. No. 6,655,071. A problem with prior technology is that it is not peripherally buoyant, which makes it unsuitable for use with non-buoyant decoys. What is needed is a need for a decoy buoy that allows non-buoyant decoys to be used in the absence of land or shallow water.

### SUMMARY OF THE INVENTION

It is therefore an object of this invention to provide a decoy buoy that may allow non-buoyant decoys to be deployed upon the surface of the water for any purpose including the visual simulation of birds feeding in shallow water or on small islands. It is another object of this invention to provide adjustable buoyancy so that a standing type decoy may be positioned entirely above the water or partially submerged according to the desire of the hunter. It is yet a further object of this invention to provide means for collapsing, stowing, and transporting the decoy buoy without disassembly. It is yet another object of this invention to provide a decoy buoy that is peripherally buoyant.

### BRIEF DESCRIPTION OF THE DRAWINGS

FIG. 1 is an isometric top view of a circular decoy buoy in a flat or open configuration with a decoy.

FIG. 2 is an isometric bottom view of a circular decoy buoy in a flat or open configuration with a decoy showing hinges.

FIG. 3 is an isometric exploded top view of a circular decoy buoy in a flat or open configuration with a decoy.

FIG. 4 is a bottom view of a half-ring section of a circular decoy buoy.

FIG. 5 is an isometric view of a half-ring section of a circular decoy buoy.

FIG. 6 is a side view of a half-ring section of a decoy buoy.

FIG. 7 is an isometric top view of an oval shaped decoy buoy in a flat or open configuration.

FIG. 8 is an isometric top view of a rectangular shaped decoy buoy in a flat or open configuration.

FIG. 9 is an isometric top view of a non-symmetrically shaped decoy buoy in a flat or open configuration.

FIG. 10 is an isometric view of a two piece hinge in a flat or open configuration.

FIG. 11 is an isometric exploded view of a two piece hinge in a flat or open configuration.

FIG. 12 is an end view of a two piece hinge in a flat or open configuration.

FIG. 13 is an exploded end view of a two piece hinge in a flat or open configuration.

FIG. 14 is an isometric view of a three piece hinge in a flat or open configuration.

FIG. 15 is an isometric exploded view of a three piece hinge in a flat or open configuration.

FIG. 16 is a top view of a circular shaped decoy buoy in a folded or closed configuration.

FIG. 17 is an isometric top view of a circular shaped decoy buoy in a folded or closed configuration.

FIG. 18 is an end view of a circular shaped decoy buoy in a folded or closed configuration.

FIG. 19 is a side view of a circular shaped decoy buoy in a folded or closed configuration.

FIG. 20 is a detail end view of the decoy buoy in a folded or closed configuration.

FIG. 21 is a side view of the decoy buoy in a flat or open configuration.

FIG. 22 is an end view of the decoy buoy in a flat or open configuration.

FIG. 23 is a detail side view of the decoy buoy in a flat or open configuration.

FIG. 24 is a top view of a half-ring embodiment of the decoy buoy that employs an internal netting design as opposed to a solid design or an open design.

FIG. 25 is an isometric top view of an X-shaped decoy retainer in a flat or open configuration with a decoy.

FIG. 26 is an isometric bottom view of an X-shaped decoy retainer in a flat or open configuration with a decoy showing living hinges.

FIG. 27 is an isometric exploded top view of an X-shaped decoy retainer in a flat or open configuration with a decoy and hinges.

FIG. 28 is a isometric view of an arm of a Y-shaped decoy retainer.

FIG. 29 is a top view of an arm of a decoy retainer.

FIG. 30 is a side view of an arm of a decoy retainer.

FIG. 31 is a bottom view of an arm of a decoy retainer.

FIG. 32 is a sliced section view of an arm of a decoy retainer.

FIG. 33 is a top view of an arm of a decoy retainer with sliced section views.

FIG. 33A is a cross-sectional view of the arm of the decoy retainer shown in FIG. 33 along line 33A.

FIG. 33B is a cross-sectional view of the arm of the decoy retainer shown in FIG. 33 along line 33B.

FIG. 33C is a cross-sectional view of the arm of the decoy retainer shown in FIG. 33 along line 33C.

FIG. 33D is a cross-sectional view of the arm of the decoy retainer shown in FIG. 33 along line 33D.

FIG. 33E is a cross-sectional view of the arm of the decoy retainer shown in FIG. 33 along line 33E.

FIG. 34 is a top view of a central hub having four sides.

FIG. 35 is a side view of a central hub.

FIG. 36 is a bottom view of a central hub

FIG. 37 is an isometric view of a two-piece hinge in a flat or open configuration.

FIG. 38 is an exploded isometric view of a two-piece hinge in a flat or open configuration.

FIG. 39 is an end view of a two-piece hinge in a flat or open configuration.

FIG. 40 is an exploded end view of a two-piece hinge in a flat or open configuration.

FIG. 41 is an isometric view of a three piece hinge in a flat or open configuration.

FIG. 42 is an isometric exploded view of a three piece hinge in a flat or open configuration.

FIG. 43 is a side view of an X-shaped decoy retainer in an open configuration with two arms hidden for clarity.

FIG. 44 is a detail view of a mounted hinge on an X-shaped decoy retainer in a folded or closed configuration.

FIG. 45 is a top view of an X-shaped decoy retainer in a folded or closed configuration.

FIG. 46 is an isometric view of an X-shaped decoy retainer in a folded or closed configuration.

FIG. 47 is a bottom view of an X-shaped decoy retainer in a folded or closed configuration.

### DETAILED DESCRIPTION OF THE INVENTION

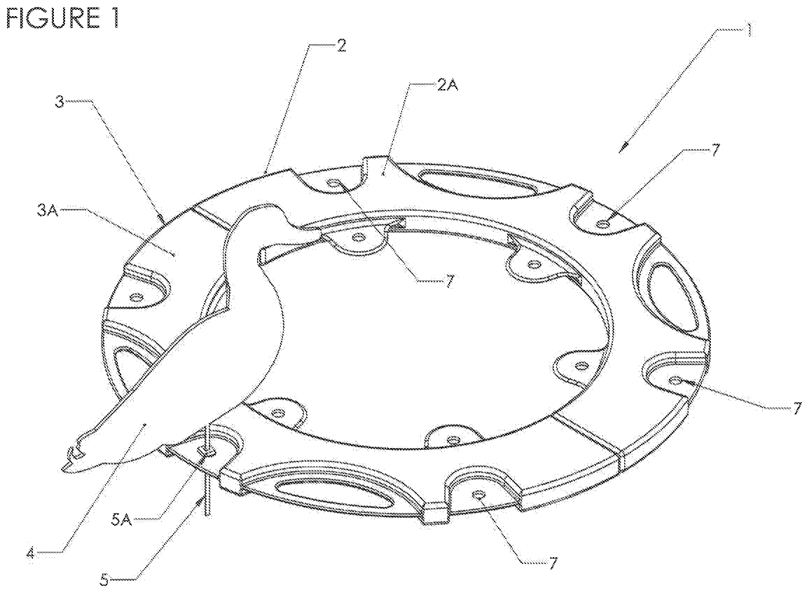

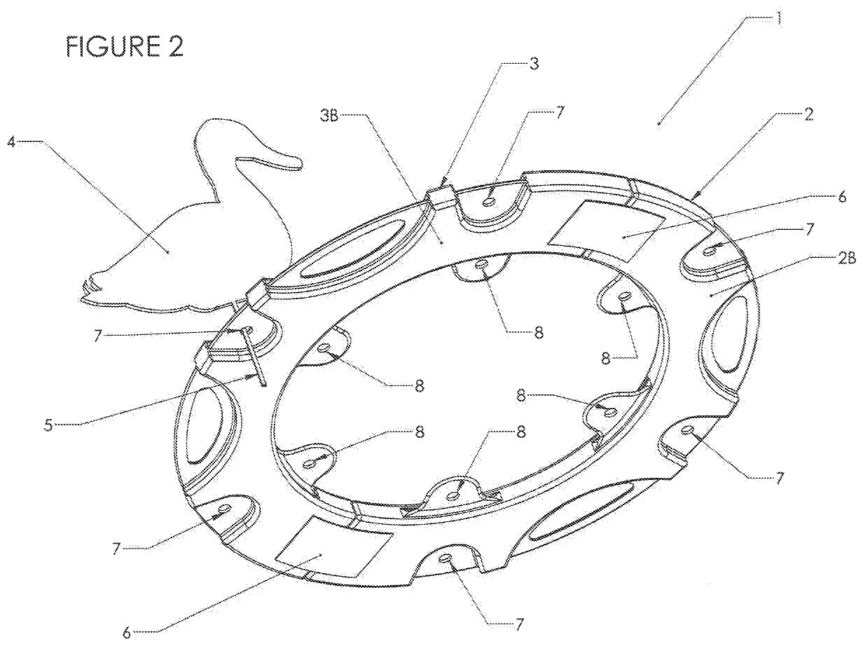

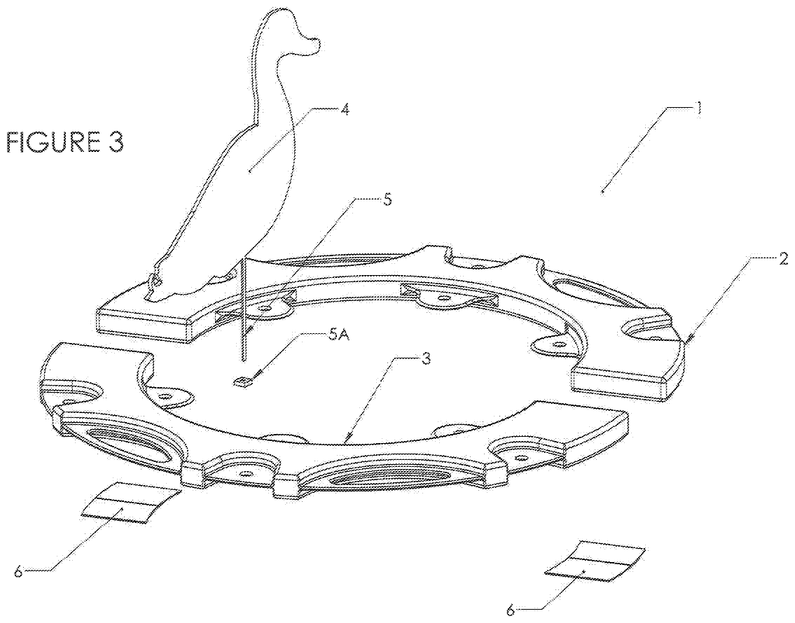

Referring now to the drawings in detail, wherein like reference numerals refer to like elements throughout, FIGS. 1-3 show a first embodiment of the claimed invention. More specifically, referring to FIGS. 1-3, the decoy buoy 1 is formed by a first generally “C” shaped symmetrical half ring decoy buoy section 2, and a second generally “C” shaped symmetrical half ring decoy buoy section 3. Decoy buoy sections 2, 3 are joined using an offset hinge member 6 as shown in FIG. 2. A decoy 4 comprising a stake 5 and a stake stopper 5A are mounted through one of the mounting bores 7 in the decoy buoy 1.

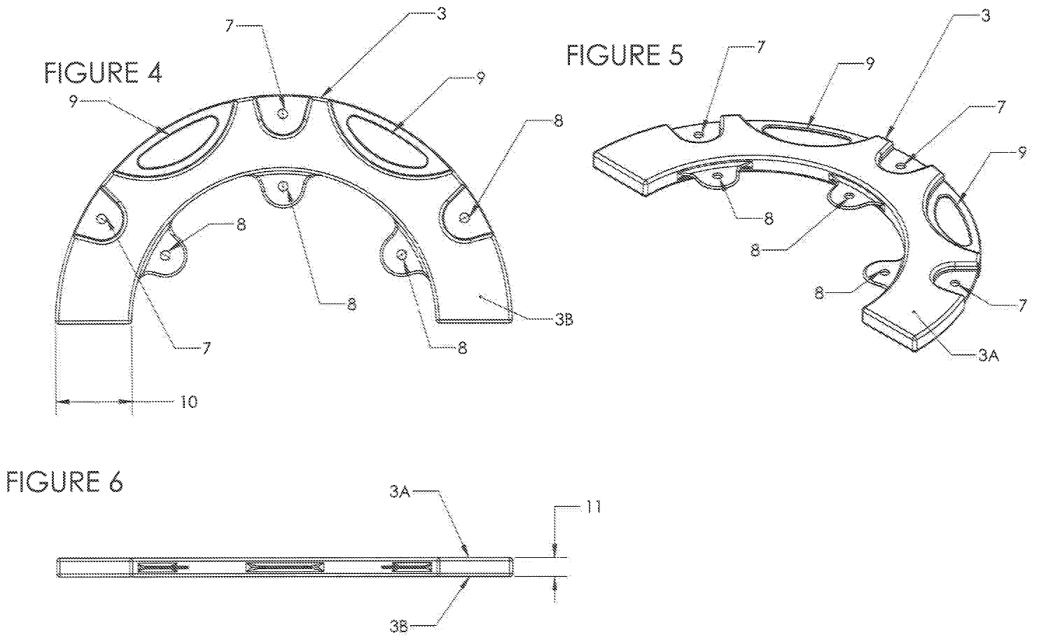

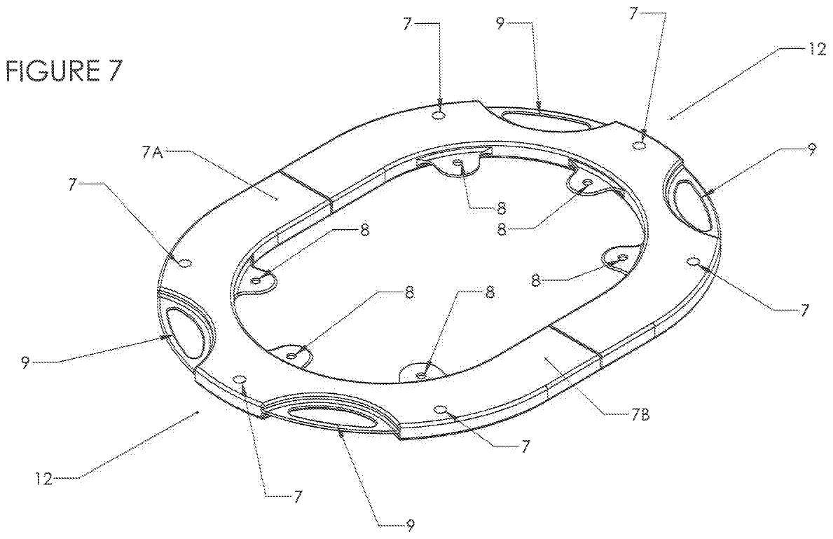

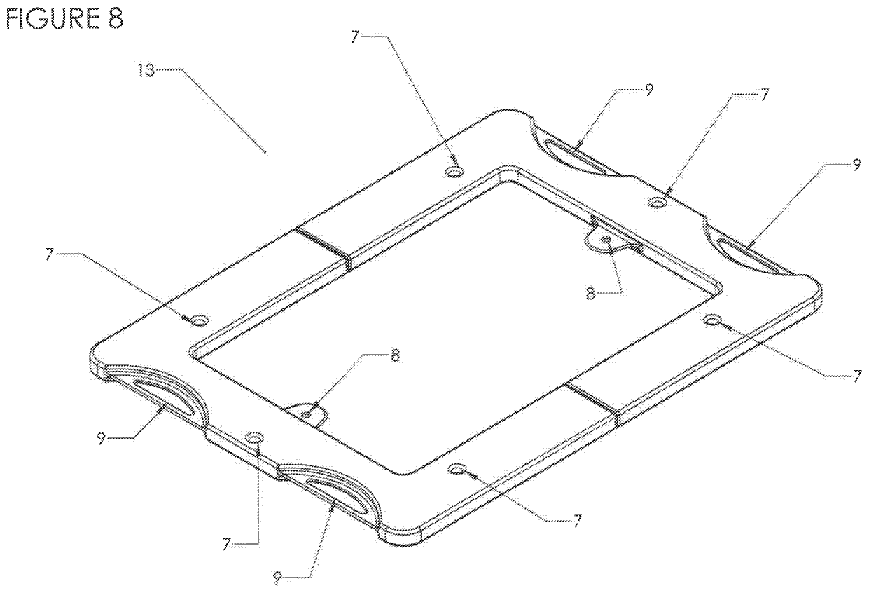

Referring now to FIGS. 4, 5, and 6, each “C” shaped decoy buoy section 2, 3 may comprise half of a round circle. Alternately, decoy buoy sections 2, 3 may be shaped like the letter “U” having elongated straight portions or may form half of an oval as shown in FIG. 7. Additionally, decoy buoy sections 2, 3 can be any suitable rounded or sided shape that has a leg that starts in a first direction 7A and ends in a substantially opposite direction 7B. It is expressly understood that decoy buoy sections could include non-circular shapes like the half rectangles shown in FIG. 8. Half squares, half diamonds, half hexagons etc. are also understood to be alternate acceptable shapes for the decoy buoy sections.

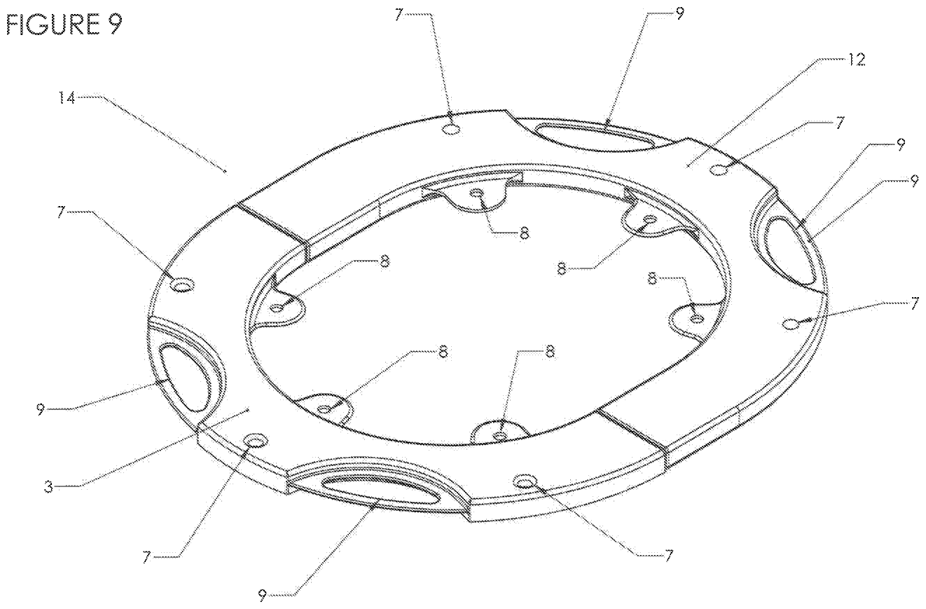

Referring now to FIG. 9, decoy buoy section 2 and decoy buoy section 3 are non-symmetrical. It is understood that it may be desirable to configure the decoy buoy with non-symmetrical decoy buoy sections.

Referring to FIGS. 4, 5, and 6 each decoy buoy section 2, 3 may be constructed so that it has a first opposing face 3A and a second opposing face 3B, each face each having a width 10 that is generally greater than or equal to the height of the decoy buoy section. Each first 3A and second face 3B may be generally planar in nature, concave, convex, or some combination thereof. A plurality of bores 7 extending transversely from said first face 3A to said second face 3B may be biased towards the outside of each decoy buoy section. A second plurality of bores 8 extending transversely from one face to the other may be biased towards the inside of each decoy buoy section.

Referring now to Figs., 25, 26, 27, and 28 in a first preferred embodiment, the retainer 31 is formed by a central hub 32 and a plurality of arms 33 and are joined by an offset hinge member 34 mounted with respect to bottom face 43 of arm 33 and bottom face 46 of central hub 32, and decoy 35 having a stake 36 are mounted with respect to one of the mounting bores 37 integral to mounting arm 33.

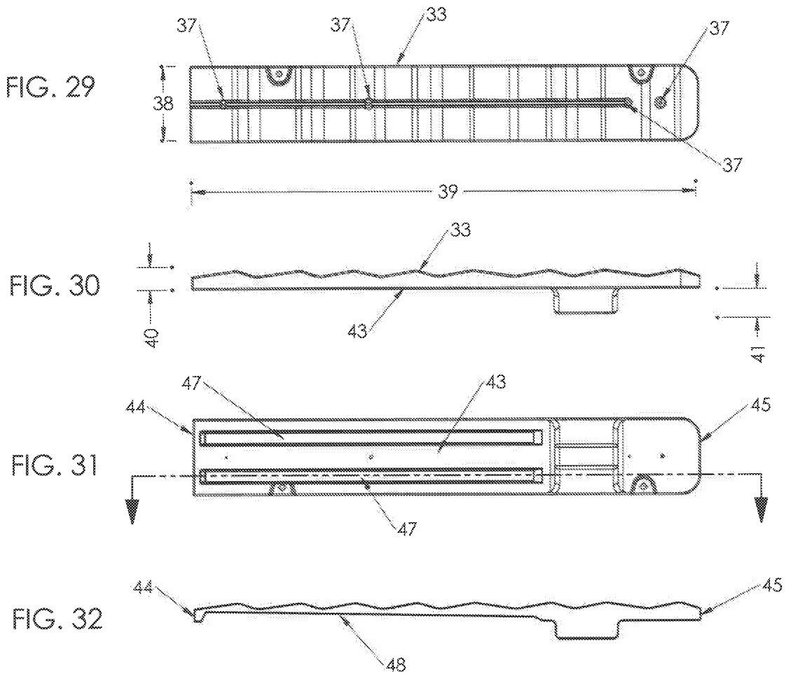

Referring now to FIGS. 29, 30, 31, and 32 each arm 43 may have a projecting width 38, an extending length 39, a first vertically projecting length 40, a second vertically projecting length 41, a mounting end 44, and a distal end 45. Top face of arm 33 may have an irregular surface 42 or may be planar or generally flat. Bottom face 43 of arm may have a planar generally flat surface or in other preferred embodiments an irregular surface. Bottom face 43 may preferably incorporate one or more recessed stiffening ribs 47. In at least one preferred embodiment, stiffening ribs 47 incorporate taper 48 such that the depth of the rib is greatest towards mounting end 44 and diminishes towards distal end 45. First vertically projecting length 40 extends upward from bottom 13 and second vertically projecting length 41 extends downward from bottom 13. Second vertically projecting length 41 is generally disposed at or towards distal end 45. Arm 33 may include one or more bores 37 configured to accept decoy stakes 36.

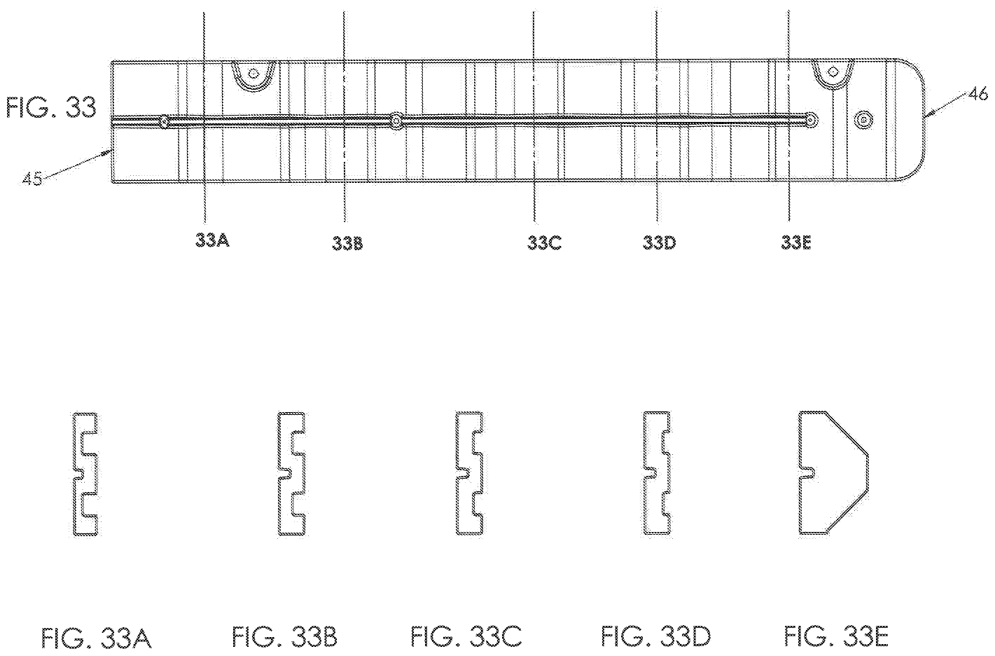

In an additional embodiment, arm 33 is hollow as shown in FIG. 32 and sealed airtight. As shown in FIGS. 33, 33A, 33B, 33C, 33D, and 33E, the volume generally increases from the mounting base end 44 towards the distal end 45. In a second preferred embodiment arm 33 may be solid and constructed from a buoyant material such as expanded foam or a combination of hollow and solid construction.

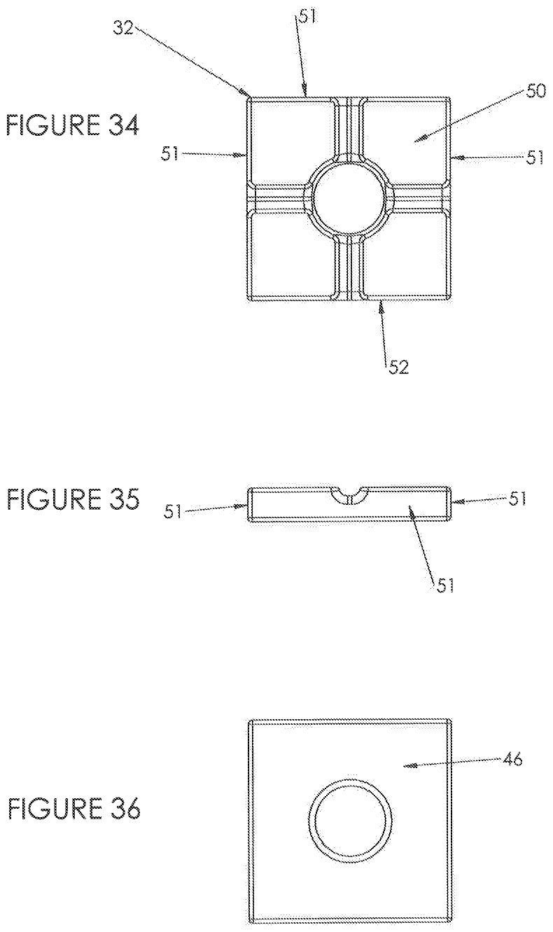

Referring to FIGS. 34, 35, and 36, central hub 32 has a top face 50, sides 51, and bottom 46. In one preferred embodiment, number of sides may correspond to number of arms. Central hub 32 may be of hollow construction and sealed airtight, or alternately may be constructed from a solid buoyant or non-buoyant material.

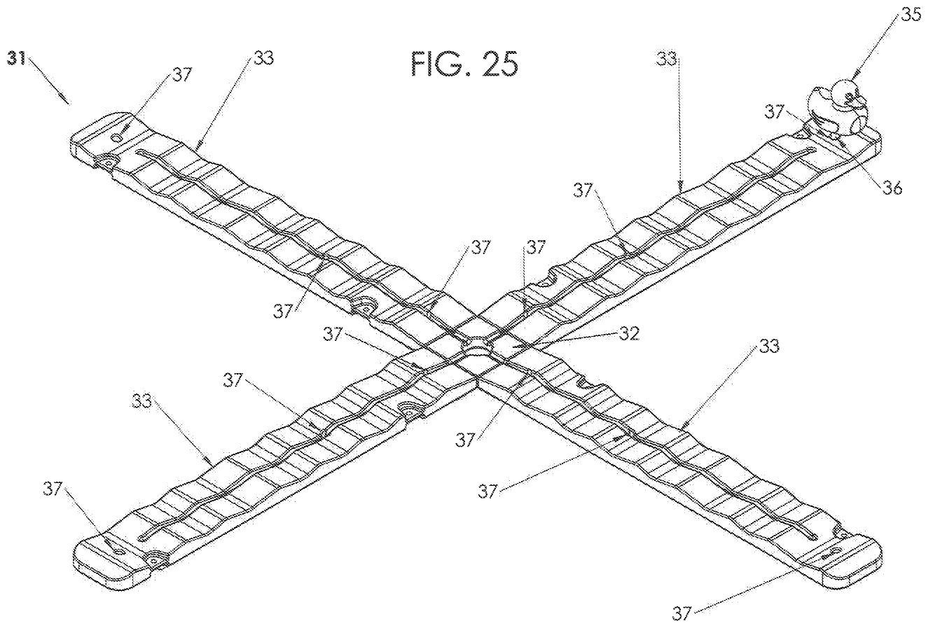

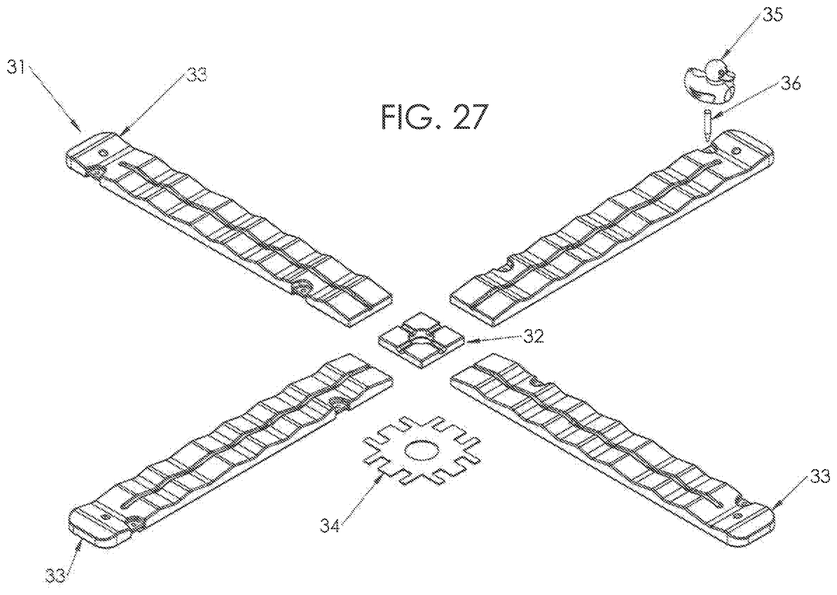

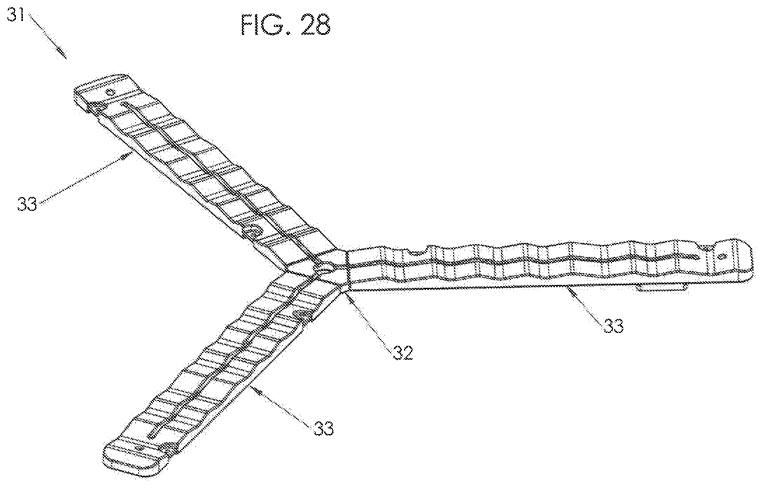

Referring to FIGS. 1, 2, 25 and 27 bores 7, 8 and 37 are sized to receive a stake 5, 36 from a two dimensional or three dimensional decoy 4, 35 an offsetting stabilizing weight, or an anchoring means. Said stake 5, 36 may be provided with means to adjust the height of the decoy of the stake. Adjustment means may comprise a press-fit bushing, a length of hose, a flat piece having a diameter that is smaller than the diameter of the stake or any other suitable means.

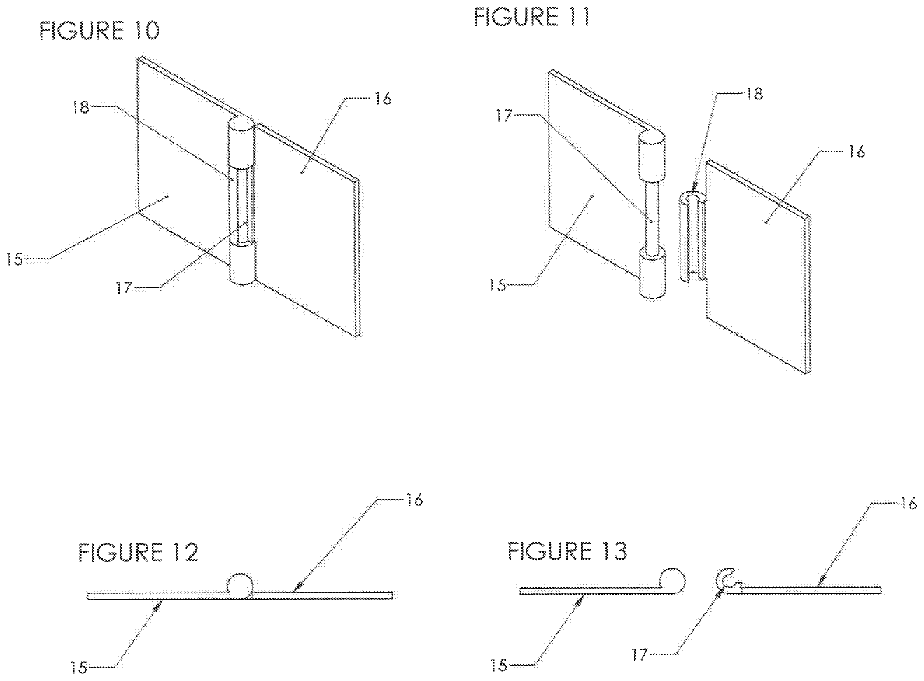

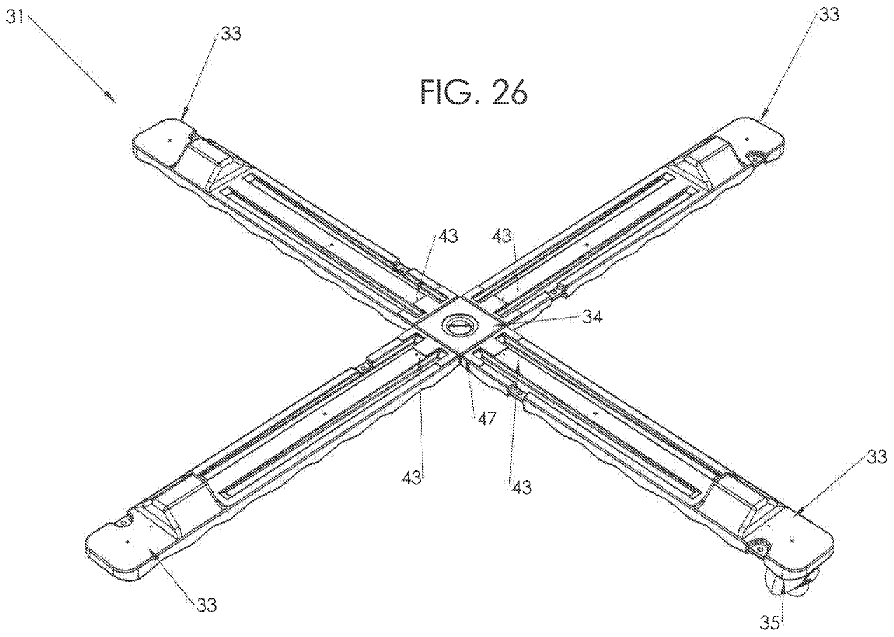

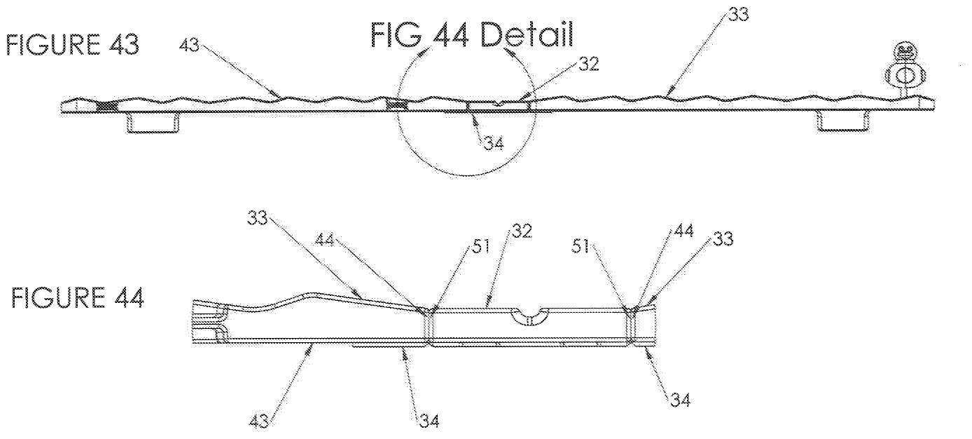

Referring to FIGS. 2, 3, 26, 27, 43 and 44 the hinge 6, 34 may be constructed as a single piece 47. Such hinges 6, 34 are often referred to as living hinges, self-hinges, and integral hinges. The hinge 6, 34 may be fixed to the decoy buoy sections 2, 3 by mechanical fasteners, bonding, ultrasonic welding, central hub 32 and arms 33 or any other suitable means. Referring now to FIGS. 10-13 and 37-40, the hinge may also be integrally molded to the decoy buoy sections 2, 3 with the “C” shaped elements 18 from the same thermoplastic material.

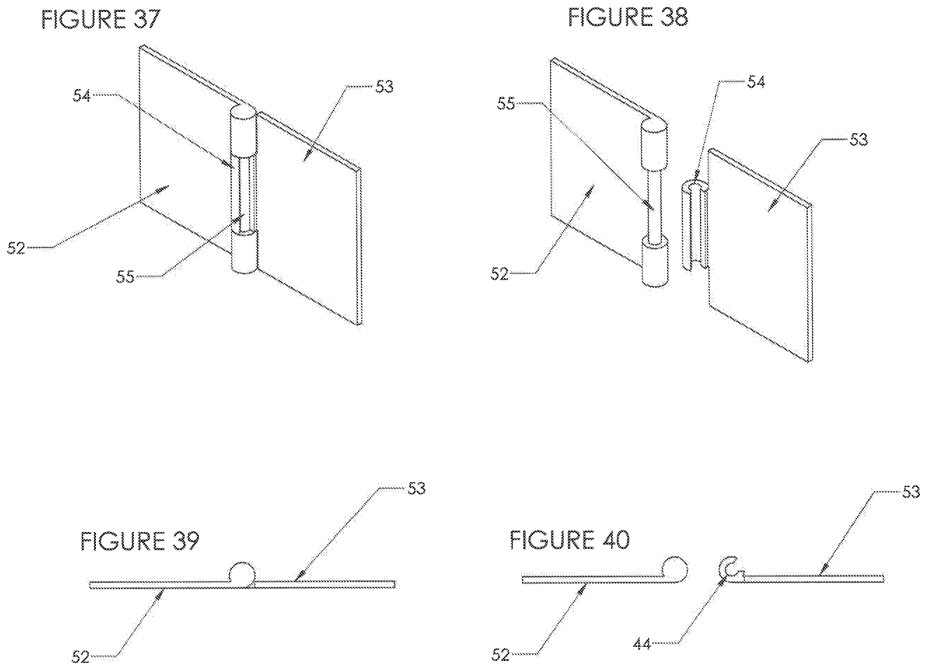

In another preferred embodiment, each arm is joined to the central hub by a hinge constructed in two pieces as shown in FIGS. 37, 38, 39 and 40 by a pin portion 55 and a complimentary receiving portion 54. In this embodiment, either the mounting end of an arm 44 or a side of the mounting hub may terminate in a hinge having a pin portion 55 and the opposite member may terminate in a receiving portion 54 that rotatably mates with a pin portion.

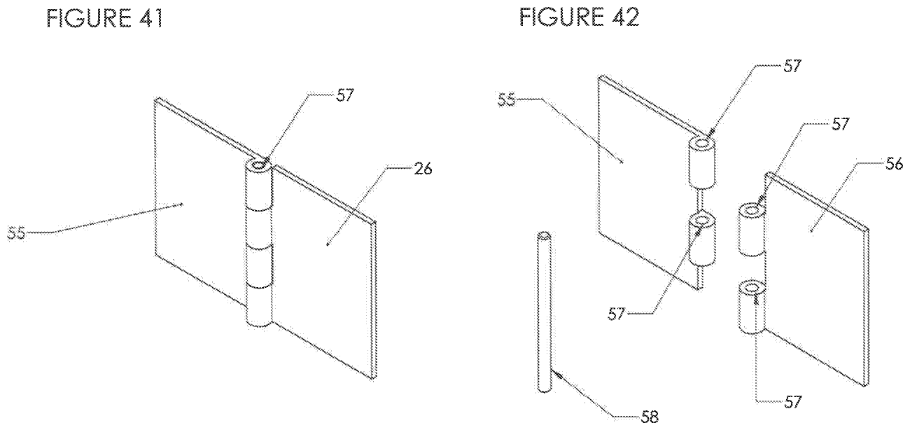

In another preferred embodiment, each arm joined to the central hub by a hinge constructed in three pieces as shown in FIGS. 41, and 42 by a pin 58 and complimentary receiving portions 57. In this embodiment, either a face of the central hub or the mounting end of an arm may terminate in a hinge having complimentary receiving portion 57 that rotatably mates with pin 58. Pin 58 may mate with the receiving portions 57 of the arm and central hub.

Referring now to FIG. 23, when placed in the water, the hinge portion 20 may be placed face down into the water so that the decoy buoy section 2, 3 end portions 19, 21 abut each other and prevent the formed ring from collapsing under the weight of the decoys.

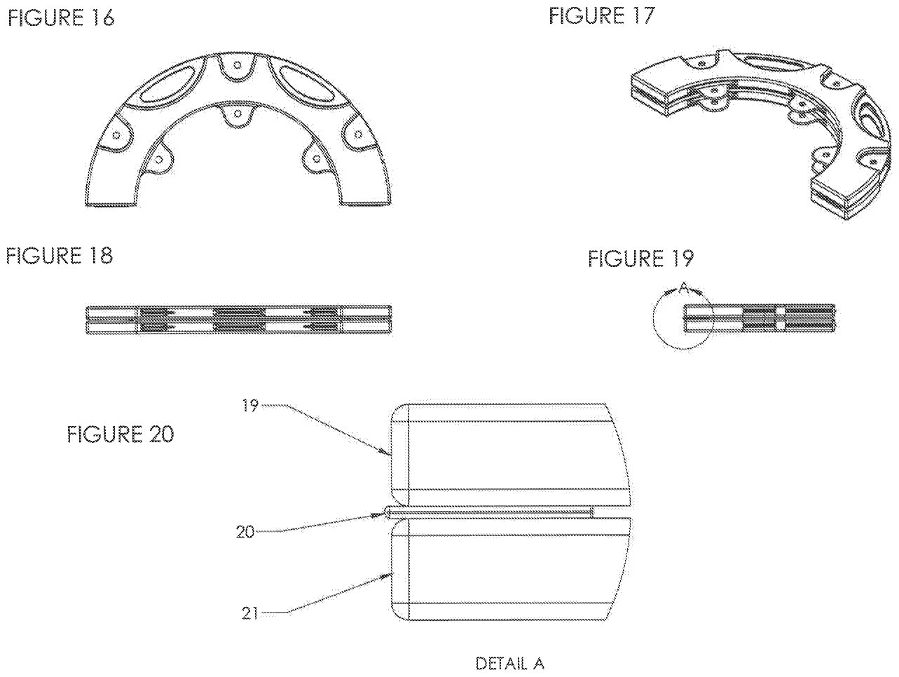

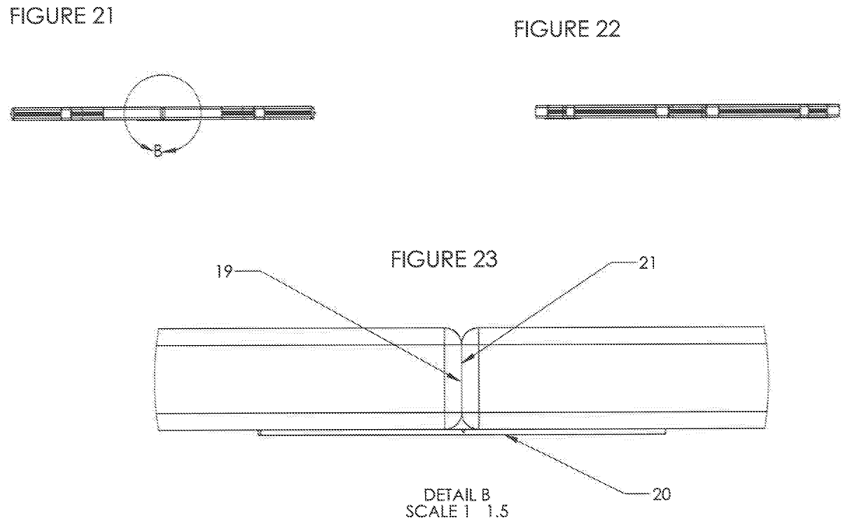

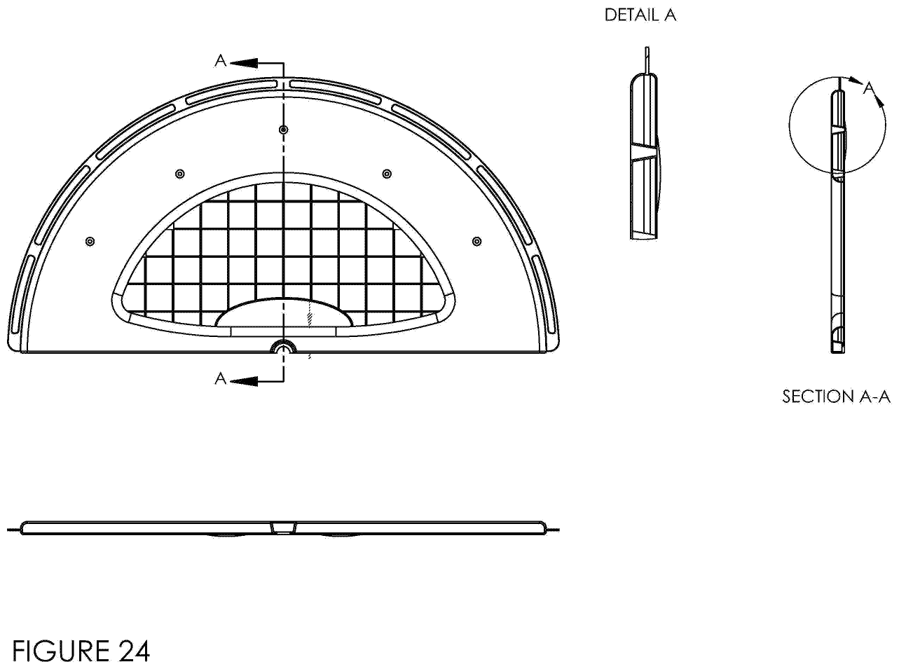

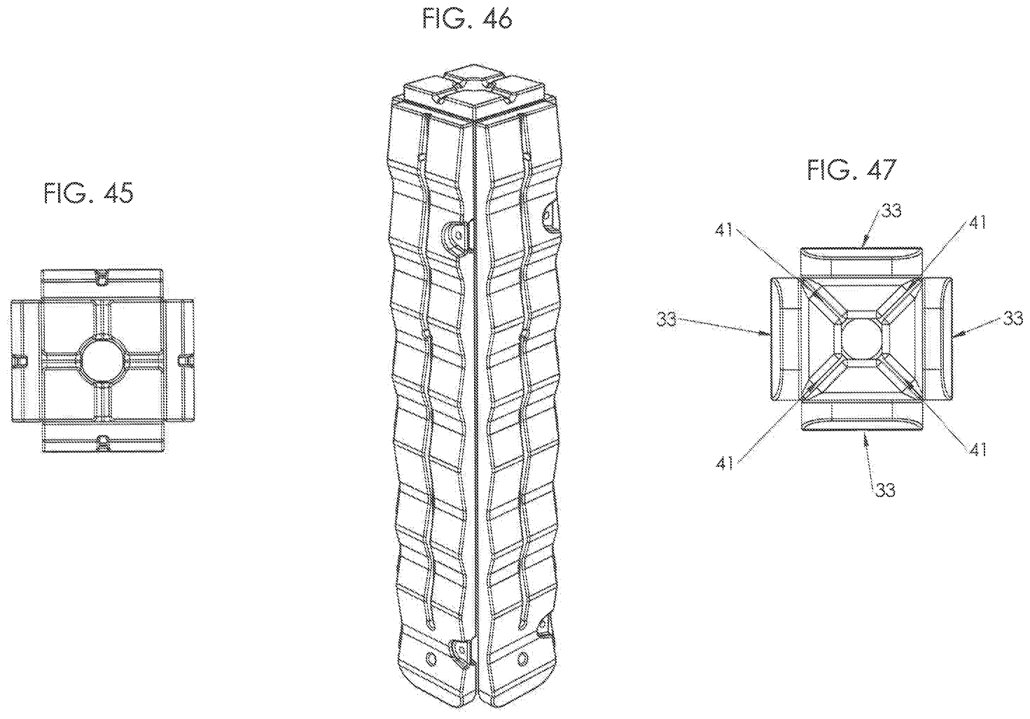

Referring to FIGS. 16-20 and 44-46 it is further understood that the assembly may be folded about the hinges into a closed configuration. As shown in FIG. 47, the second vertical portion 41 of at least two arms 33 abut each other in the closed configuration. The arms 33 and central hub may be formed from materials such as lightweight polymer materials such as polyethylene, LDPE, HDPE, and expanded polystyrene foam as well as a host of other buoyant materials. The decoy buoy sections 2, 3 may be formed by injection molding, blow molding, thermoforming as well as a host of other preferred methods. They decoy buoy sections 2, 3 may be of solid construction throughout or may be formed to have hollow sections that trap air and facilitate buoyancy.

In another preferred embodiment, each decoy buoy section is joined by a hinge constructed in two pieces as shown in FIGS. 10, 11, 12 and 13: a pin portion 17 and a complimentary receiving portion 18. In this embodiment, one end of the decoy buoy section may terminate in a hinge having a pin portion 15 and the opposite end of the half ring may terminate in a complimentary portion 16 that rotatably mates with a pin portion. Due to the symmetrical placement of the hinge pieces on the ends of the decoy buoy section, the pin portion 15 of one end may mate with the receiving portion 18 of the opposite decoy buoy section.

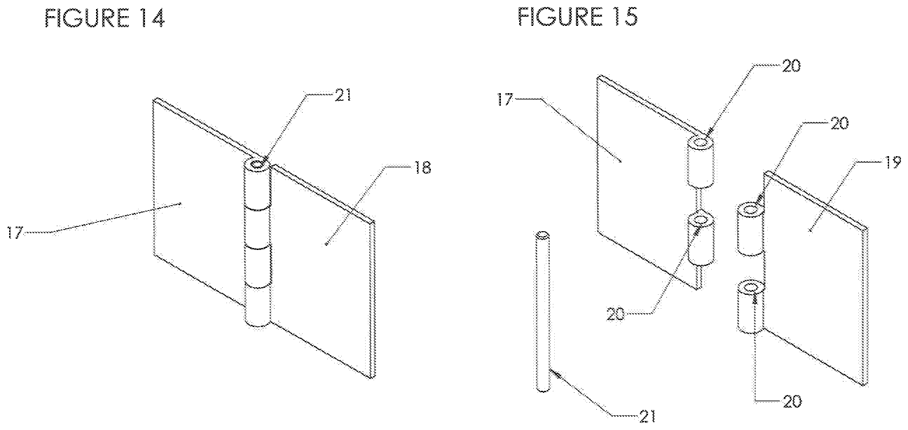

In yet another preferred embodiment, each decoy buoy section 2, 3 is joined by a hinge constructed in three pieces as shown in FIGS. 14, and 15, a pin 21 and complimentary receiving portions 20. In this embodiment, one end each decoy buoy section 2, 3 may terminate in a hinge having complimentary receiving portion 20 that rotatably mates with pin portion 21. Due to the symmetrical placement of the hinge pieces on the ends of the decoy buoy sections, the pin 21 may mate with the receiving portions 21 of each opposite decoy buoy section.

What is claimed is:

1. A retainer for holding at least one waterfowl decoy comprising:
a central hub having sides and a top and a bottom,
at least three arms, each arm having a top, a bottom, a mounting end and a distal end, and mounting bores wherein each of the plurality of bores being adapted to receive at least one of: a decoy stake, an anchoring means, or a stabilizing weight,
at least one hinge rotatably joining said central hub to each of said arms at a mounting end,
whereby bottom of said central hub and bottom of said arms are generally parallel in an open position and generally perpendicular in a closed position,
and whereby said arms are buoyant.

2. The retainer of claim 1 wherein said arms are more buoyant towards their distal end than their mounting end.

3. The retainer of claim 2 wherein each of said arms is constructed with a hollow core to provide buoyancy.

4. The retainer of claim 2 wherein each of said arms is constructed of a rigid expanded polymer foam to provide buoyancy.

5. The retainer of claim 2 wherein each of said half rings is constructed with a hollow core and of a rigid foam to provide buoyancy.

6. The retainer of claim 2 wherein each of said half rings is constructed from low density polyethylene to provide buoyancy.

7. The retainer of claim 2 wherein each of said half rings is constructed from high density polyethylene to provide buoyancy.

8. The retainer of claim 1 wherein said hinge means comprises a living hinge.

9. The retainer of claim 1 wherein one of said arms or central hub comprises a hinge half having a pin portion and second terminus comprises a pin receiving portion.

10. The retainer of claim 1 wherein one of said arms or central hub comprises a pin receiving portion and the half rings are joined by at least one hinge pin.

17. The system of claim 2 wherein the decoy is two dimensional.

18. The system of claim 2 wherein the decoy is three dimensional.

18. The system of claim 2 wherein the height of the stake is adjustable.
